(19) United States
(12) Patent Application Publication
(10) Pub. No.: US 2024/0211662 A1
(43) Pub. Date: Jun. 27, 2024

(54) CALCULATING AND REAL-TIME MONITORING METHOD FOR BOUNDARY OF BLAST FURNACE TUYERE RACEWAY

(71) Applicant: Northeastern University, Shenyang City (CN)

(72) Inventors: Peisheng LIU, Shenyang City (CN); Hao LI, Shenyang City (CN); Yingwei ZHANG, Shenyang City (CN); Lin FENG, Shenyang City (CN)

(21) Appl. No.: 18/555,827

(22) PCT Filed: Dec. 3, 2021
(86) PCT No.: PCT/CN2021/135430

§ 371 Date: Oct. 17, 2023

(30) Foreign Application Priority Data
May 24, 2021 (CN) 202110566801.4

(51) Int. Cl. G06F 30/27; G06F 113/08; G06F 119/08

(52) U.S. Cl. CPC G06F 30/27; G06F 2113/08; G06F 2119/08

(57) ABSTRACT

Provided is a calculating and real-time monitoring method for a boundary of a blast furnace tuyere raceway including: the steps of firstly establishing a depth calculation model for the raceway, and further obtaining a calculation formula for a depth of the raceway so as to obtain a change law of the depth of the raceway; establishing a boundary model for the raceway through the depth calculation model for the raceway, and determining a calculation formula for the boundary of the raceway; obtaining modelling parameters, analyzing an impact of the modelling parameters on the boundary model, and determining main parameters that affect the boundary of the raceway; finally, solving a height of the raceway; and when the height or depth of the raceway exceeds a set range, adjusting a blast wind pressure and a blast wind volume to restore the height or depth of the raceway to a normal range.

### BACKGROUND OF THE INVENTION

### 1. Field of the Invention

The present invention relates to the technical field of blast furnace ironmaking processes, in particular to a calculating and real-time monitoring method for a boundary of a blast furnace tuyere raceway.

### 2. The Prior Arts

During blast furnace ironmaking production, high-temperature high-speed air is blown into a blast furnace through a blast furnace tuyere. Due to the effect of blast wind, a region in which coke circulates is formed near the front of a tuyere, which is called a blast furnace tuyere raceway. The tuyere raceway is located at the front end of the lower tuyere of a vertical furnace body, and is formed by an intense combustion reaction between coke and auxiliary fuel injected into the furnace and oxygen in the blast wind. Mixed airflow of the blast wind and gas performs circulating motion in the region, accompanied by high-speed rotation of small coke granules and unburned coal powder, as well as a burnout process of crushed coke in a swirling process. The size of the raceway is directly related to blast wind parameters, raw fuel conditions and other factors. It is the birthplace of heat energy and a gas reducing agent, providing heat and energy supply for the whole blast furnace production. The depth of the tuyere raceway and complex physical and chemical reactions inside determine the primary distribution of coal gas flow in the blast furnace and the declining state of upper furnace charge, reflect the burning state of the coke, is the basis for smooth operation of furnace conditions, and plays a crucial role in the smelting process.

The study on the characteristics of the blast furnace tuyere raceway can be mainly divided into two aspects: direct method study on the characteristics of the raceway and indirect method study on the characteristics of the raceway. Firstly, for the direct study method on the characteristics of the blast furnace tuyere raceway, study is carried out by directly detecting the relevant parameters that represent the blast furnace raceway, mainly focusing on the direct measurement of parameters such as the size, shape, and temperature of the raceway. However, there are problems of significant fluctuations in measurement results caused by the situation that instrument equipment is easy to affect by the actual environment inside the furnace, high instrument cost, and inability to achieve real-time monitoring, so that the direct study method cannot be fully popularized in small and medium enterprises. The direct study method can be divided into study by an empirical observation method and study by an actual measurement method. Secondly, the indirect study method on the characteristics of the blast furnace raceway, namely a model study method, comprises the following two aspects: firstly, by establishing a physical parameter experimental model of the blast furnace tuyere raceway, experimental detection is carried out on the model based on the characteristics of the blast furnace tuyere raceway. However, due to the internal presence of the raceway but the complex and variable reactions inside the raceway, a cold-state model cannot reflect the actual internal state of the raceway well. A commonly used method is to establish an Euler mathematical model for solving based on the transfer of momentum, mass and heat during the motion of the raceway. However, if existing Euler models are adopted, modelling is complex, a large number of parameters are required, calculation is difficult, a long time is consumed, the purpose of real-time monitoring of reactions is difficult to achieve, and experimental models cannot reflect the actual internal state of the raceway well. Secondly, an established two-dimensional or three-dimensional mathematical model for the blast furnace tuyere raceway is used for numerically simulating the chemical reaction process in the raceway, so as to achieve the purpose of studying the characteristic change law of the raceway.

### SUMMARY OF THE INVENTION

A technical problem to be solved by the present invention is to provide a calculating and real-time monitoring method for a boundary of a blast furnace tuyere raceway so as to address the shortcomings of a direct measurement method and an experimental model method mentioned above, and to improve a mechanism mathematical model. On the basis of a depth model for a raceway, by establishing an equilibrium equation of two forces at each point at the boundary of the raceway, the changes in the boundary of the raceway can be solved efficiently in real time, the change law of the boundary of the raceway is obtained, the impact of internal parameters of the raceway on the depth and height of the raceway is studied, the changes in the depth and height of the raceway are adjusted by controlling blast wind parameters, and reliable guarantees are provided for the stable operation of the blast furnace.

To solve the above-mentioned technical problems, the technical solution adopted by the present invention is to provide a calculating and real-time monitoring method for the boundary of a blast furnace tuyere raceway, comprising the following steps.

Step 1: establishing a depth calculation model for the raceway according to a formation principle of the blast furnace tuyere raceway, and further obtaining a calculation formula for a depth of the raceway so as to obtain a change law of the depth of the raceway.

When a cavity in the raceway is in a stable motion state, taking a micro element region A at a deepest position inside the raceway as a research object, at this time, enabling the region A to be balanced under a combined action of a blast wind gas impulse and a resistance of a coke layer, and establishing the depth calculation model for the raceway according to an equilibrium of two forces to solve changes of the depth of the raceway, as shown in the following formulas:

$${F}_{A} ∝ {{ρ}_{g 0} ( \frac{{V}_{g}}{{s}_{T}} )}^{2} \cdot {( \frac{{D}_{T}}{{D}_{R}} )}^{4 α} \cdot \frac{{T}_{m}}{{T}_{w}} \cdot {S}_{P} ,$$

$${F}_{B} ∝ {ρ}_{p} \cdot {V}_{p} \cdot g \cdot P ∝ {ρ}_{P} \cdot \frac{4}{3} π \cdot {( \frac{{D}_{P R}}{2} )}^{3} \cdot g \cdot P .$$

Wherein F_{A} represents the blast wind gas impulse at the region A, F_{B} represents the resistance of the coke layer at the region A, ρ_{g0} represents a blast wind density in a standard state, V_{g} represents the blast wind volume at the region A, S_{T} represents an area of a tuyere, D_{R} represents the depth of the raceway, D_{T} represents a diameter of the tuyere, α is a constant which is used for representing a relationship between the depth and a width of the raceway, P represents the blast wind pressure, Tₘ represents a temperature of the raceway, Sₚ represents a total cross-sectional area of coke particles at the region A, pₚ represents a coke density, Vₚ represents a volume of the coke particles at the region A, g represents an acceleration of gravity, D_{PR} represents a diameter of coke in front of the boundary of the raceway, D_{PR}=0.6D_{PC}, D_{PC} represents a diameter of the coke before entering a furnace, and T_{w} represents blast wind temperature.

The calculation formula for the depth of the raceway is obtained through the depth calculation model for the raceway:

$${D}_{R} = K \cdot {{D}_{T} [ {{ρ}_{g} ( \frac{{V}_{g}}{{S}_{T}} )}^{2} \cdot \frac{1}{P} \cdot \frac{{T}_{m}}{{T}_{w}} \cdot \frac{1}{{ρ}_{P} \cdot {D}_{P c} \cdot g} ]}^{β} .$$

Wherein K and β both are coefficients to be determined, and ρ_{g} represents a blast wind density under an actual wind temperature and wind pressure.

Step 2: establishing a boundary model for the blast furnace tuyere raceway through the depth calculation model for the blast furnace tuyere raceway, and determining a calculation formula for the boundary of the raceway.

When an internal motion of the raceway is in a stable state, randomly taking a point B at the boundary of the raceway as a research object, at this time, enabling the point B to be balanced under the combined action of the blast wind gas impulse and the resistance of the coke layer, and establishing a mathematical model for any point at the boundary of the raceway according to the equilibrium of two forces to solve changes of the boundary of the raceway.

$${F}_{D} ∝ \frac{( {M}_{B} \cdot {U}_{B} )}{{S}_{B}} \cdot {S}_{P} ,$$

$${F}_{D} ∝ {ρ}_{g} \cdot ( 1 - σ ( {( {D}_{R} - x )}^{a} + {h}^{b} ) ) \cdot {( \frac{{V}_{g}}{{S}_{T}} )}^{2} \cdot {( \frac{{D}_{R}}{{D}_{T}} )}^{a} \cdot \frac{{T}_{m}}{{T}_{W}} \cdot {S}_{P} ,$$

$$wherein$$

$${S}_{P} ∝ {\sum }_{i = 1}^{I} {( \frac{{D}_{PR}^{i}}{2} )}^{2} \cdot π \cdot ( 1 - σ L ) ,$$

$${M}_{B} ∝ {ρ}_{g} \cdot {V}_{g} \cdot ( 1 - σ L ) ,$$

$${U}_{B} ∝ \frac{{M}_{B}}{{ρ}_{g} \cdot {S}_{B}} \cdot \frac{{P}_{0}}{P} \cdot \frac{{T}_{m}}{{T}_{0}} ,$$

$${S}_{B} ∝ ( 1 - σ ( {( {D}_{R} - x )}^{a} + {h}^{b} ) ) \cdot {S}_{A} ,$$

$${F}_{b} ∝ \frac{H - h}{H} \cdot {ρ}_{P} \cdot {V}_{P} \cdot g ∝ \frac{H - h}{H} \cdot {ρ}_{P} \cdot {P ( \frac{{D}_{PR}}{2} )}^{3} \cdot g .$$

F_{D} represents a blast wind gas impulse at the point B, F_{b} represents a resistance of the coke layer at the point B to a blast wind airflow, M_{B} represents a blast wind mass flow rate at the point B, U_{B} represents a wind speed at the point B, S_{B} represents a cross-sectional area of the point B, S_{A} represents a cross-sectional area of the region A, ρ_{g} represents the blast wind density under the actual wind temperature and wind pressure, P₀ represents 1 standard atmospheric pressure, L represents a curve distance from the deepest position of the raceway to any point on the boundary of the raceway, σ represents a loss rate of blast wind on the boundary of the raceway, H represents a total height of a blast furnace, h represents a vertical distance from the point B to the tuyere, a and b are shape parameters of the boundary of the raceway, I represents a total number of coke granules included in the cross-section at the point B, and D_{PR}ⁱ is a diameter of an i^{th} coke granule at the point B of the boundary of the raceway.

Because the boundary from the deepest position of the raceway to any point on the boundary of the raceway is in a curved shape, L=(D_{R}−x)^{a}+h^{b} is set, and wherein coordinates of the point B of the boundary of the raceway relative to the tuyere are (x, h).

The calculation formula for the boundary of the raceway is further obtained through the mathematical model for any point at the boundary of the raceway.

$${K}_{1} \cdot {x}^{2} - 2 {K}_{1} \cdot {D}_{R} \cdot x + {K}_{1} \cdot {h}^{2} - {K}_{2} \cdot h = {K}_{3} ,$$

$$wherein$$

$${K}_{1} = {K}_{3} \cdot \frac{{V}_{g}^{2} \cdot {D}_{R}^{a} \cdot {T}_{m} \cdot σ}{P \cdot {T}_{w}} ,$$

$${K}_{2} = {K}_{4} \cdot \frac{{ρ}_{p} \cdot {D}_{PR}^{3} \cdot g}{H} P ,$$

$${K}_{3} = {K}_{4} \cdot {ρ}_{p} \cdot {D}_{PR}^{3} \cdot g \cdot P - \frac{{ρ}_{g} \cdot {S}_{p}}{{S}_{T}^{2} \cdot {D}_{T}^{a}} \cdot \frac{{V}_{g}^{2} \cdot {D}_{R}^{a} \cdot {T}_{m}}{P \cdot {T}_{w}} + \frac{{ρ}_{g} \cdot {S}_{P} \cdot σ}{{S}_{T}^{2} \cdot {D}_{T}^{a}} \cdot \frac{{V}_{g}^{2} \cdot {D}_{R}^{a + 2} \cdot {T}_{M}}{P \cdot {T}_{W}} .$$

K₄ and K₄ are coefficients to be determined.

Step 3: obtaining modelling parameters, analyzing an impact of the modelling parameters on the boundary model for the raceway, and determining main parameters that affect the boundary of the raceway.

According to the boundary model for the raceway and relevant parameters involved in modelling, and a change law of the boundary of the raceway, the blast wind pressure P and the blast wind volume V_{g} in blast wind parameters, as well as the temperature Tₘ of the raceway and the loss rate σ of the blast wind at the coke of the raceway in the blast wind parameters, have a direct impact on the changes of the boundary of the raceway; according to the calculation formula for the boundary of the raceway, reducing the blast wind pressure P, increasing the blast wind volume V_{g} and increasing the temperature Tₘ and reducing the loss rate of the blast wind at the coke of the raceway are all beneficial for developing the raceway towards a center and increasing the depth of the raceway, wherein the blast wind pressure P and the blast wind volume V_{g} are adjustable, while changes of the temperature Tₘ in the raceway are influenced by various factors, whereby the temperature is not directly adjustable to cause changes.

Step 4: solving a height of the raceway through the calculation formula for the boundary of the raceway.

Deriving a variable h in the calculation formula for the boundary of the raceway, and making the derived result equal to zero, thereby calculating a maximum value of the raceway in a vertical direction, that is, the height of the raceway, as shown in the following formula:

$$G = \frac{{K}_{2}}{2 \cdot {K}_{1}} = \frac{{ρ}_{P} \cdot {D}_{P R}^{3} \cdot g \cdot {P}^{2} \cdot {T}_{w}}{{K}_{5} \cdot {V}_{g}^{2} \cdot {D}_{R}^{a} \cdot {T}_{m} \cdot H} .$$

Wherein G is the height of the raceway, and K₅ is a coefficient to be determined.

Step 5: when the height or the depth of the raceway exceeds a set range, adjusting a blast wind pressure P and a blast wind volume V_{g} to restore the height or the depth of the raceway to a normal range.

Beneficial effects generated by adopting the above technical solution lie in that in the calculating and real-time monitoring method for the boundary of a blast furnace tuyere raceway provided by the present invention, firstly, the depth model for the raceway is determined, based on the depth model, the mathematical model for any point on the boundary of the raceway is deduced through physical principles and chemical principles, and through the mathematical model, the pocket shape of the blast furnace tuyere raceway can be intuitively reflected; the variable of temperature of the raceway is successfully introduced, two blast wind parameters that affect the depth and boundary of the raceway, namely blast wind pressure and blast wind temperature are obtained, the impact of the two parameters on the changes in the depth and boundary of the raceway is studied, and when there are unreasonable changes in the depth and boundary of the raceway, the two parameters are adjusted timely to restore the depth and boundary of the raceway to the normal range. According to the method disclosed by the present invention, the changes of the depth and boundary of the raceway can be monitored in real-time, providing safety guidance for the actual production of blast furnaces so as to ensure the safety of life and property of enterprises.

### BRIEF DESCRIPTION OF DRAWINGS

FIG. 1 is a schematic diagram of the formation of a blast furnace tuyere raceway according to embodiments of the present invention;

FIG. 2 is a schematic diagram of modelling for a depth calculation model for the raceway according to the embodiments of the present invention, wherein (a) is an overall schematic diagram of modelling for the depth mechanism model of the raceway, and (b) is a forward cross-sectional view of a tuyere;

FIG. 3 is a schematic diagram of modelling for a boundary model of the raceway according to the embodiments of the present invention;

FIG. 4 is a schematic diagram of a change law for the depth of the raceway according to the embodiments of the present invention; and

FIG. 5 is a schematic diagram of the change law for the height of the raceway according to the embodiments of the present invention.

### DETAILED DESCRIPTION OF THE PREFERRED EMBODIMENT

The specific implementations of the present invention are described in more detail below with reference to the accompanying drawings and embodiments. The following embodiments are intended to illustrate the present invention, rather than to limit the scope of the present invention.

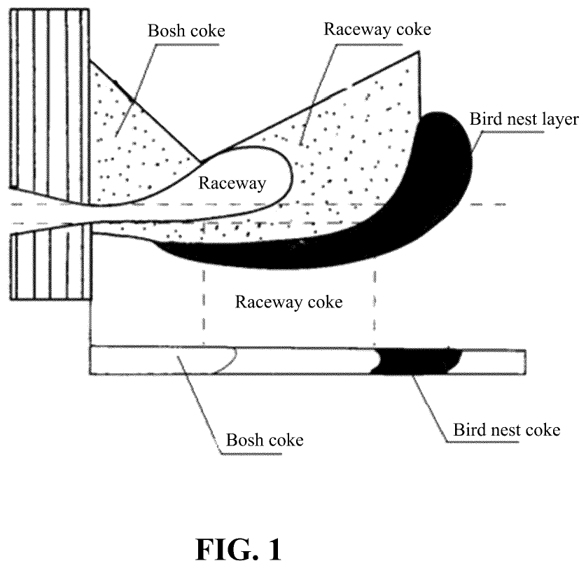

The formation of the blast furnace tuyere raceway is shown in FIG. 1. In the ironmaking process of the blast furnace, when leaving the tuyere, blast wind has strong kinetic energy, blows coke in front of the tuyere and undergoes a combustion reaction with the coke, forming a loose and approximately elliptical gas phase cavity in the front edge of the tuyere. In addition, the gas flow in front of the tuyere takes the raceway as a radiating center, and develops along a long diameter to a center of a furnace cylinder and develops along a short diameter to two sides. At the same time, new coke is constantly added from the upper part and two sides of the cavity to make the coke rotate in the cavity. The region is the blast furnace tuyere raceway. The embodiment takes a 4000 m³ blast furnace as an example, and when a calculating and real-time monitoring method for the boundary of a blast furnace tuyere raceway disclosed by the present invention is used, calculation and real-time monitoring of the boundary of the blast furnace tuyere raceway are achieved.

In the embodiments of the present invention, based on the depth calculation model for the raceway, a research object is any point B on the boundary of the raceway. By analyzing the force at the point B and comparing the force with that in the deepest point, a boundary model of the raceway is established, and monitoring the boundary of the raceway is carried out based on the boundary model of the raceway.

A calculating and real-time monitoring method for each point on the boundary of a blast furnace tuyere raceway comprises the following steps.

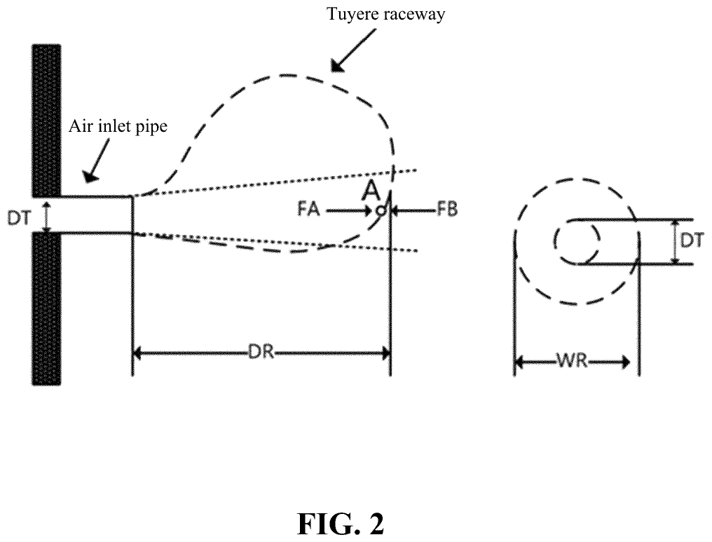

Step 1: establishing a depth calculation model for the raceway according to a formation principle of the blast furnace tuyere raceway, as shown in FIG. 2, and further obtaining a calculation formula for a depth of the raceway so as to obtain a change law of the depth of the raceway.

When an internal motion of the raceway is in a stable state, taking a region A at a deepest position inside the raceway as a research object, at this time, enabling the region A to be balanced under a combined action of a blast wind gas impulse and a resistance of a coke layer, and establishing the depth calculation model for the raceway according to an equilibrium of two forces to solve changes of the depth of the raceway, as shown in the following formula:

$${F}_{A} ∝ {{ρ}_{g 0} ( \frac{{V}_{g}}{{S}_{T}} )}^{2} \cdot {( \frac{{D}_{T}}{{D}_{R}} )}^{4 α} \cdot \frac{{T}_{m}}{{T}_{w}} \cdot {S}_{P} ,$$

$${F}_{B} ∝ {ρ}_{P} \cdot {V}_{P} \cdot g \cdot P ∝ {ρ}_{P} \cdot \frac{4}{3} π \cdot {( \frac{{D}_{P R}}{2} )}^{3} \cdot g \cdot P .$$

Wherein F_{A} represents the blast wind gas impulse at the region A, F_{B} represents the resistance of the coke layer at the region A, ρ_{g0} represents a blast wind density in a standard state, V_{g} represents the blast wind volume at the region A, S_{T} represents an area of the tuyere, D_{R} represents the depth of the raceway, D_{T} represents a diameter of the tuyere, a is a constant which is used for representing a relationship between the depth and a width of the raceway, P represents the blast wind pressure, Tₘ represents a temperature of the raceway, measured by a CCD temperature measuring instrument, S_{P} represents the total cross-sectional area of coke particles at the region A, ρₚ represents a coke density, V_{P} represents a volume of the coke particles at the region A, g represents an acceleration of gravity, D_{PR} represents a diameter of coke in front of the boundary of the raceway, D_{PR}=0.6D_{PC}, D_{PC} represents a diameter of the coke before entering the furnace, ρ_{g} represents blast wind density under actual wind temperature and wind pressure, and T_{w} represents a blast wind temperature.

The calculation formula for the depth of the raceway is obtained through the depth calculation model for the raceway:

$${D}_{R} = K \cdot {{D}_{T} [ {{ρ}_{g} ( \frac{{V}_{g}}{{S}_{T}} )}^{2} \cdot \frac{1}{P} \cdot \frac{{T}_{m}}{{T}_{w}} \cdot \frac{1}{{ρ}_{P} \cdot {D}_{P c} \cdot g} ]}^{β} . \qquad ( 1 )$$

Wherein K and β are coefficients to be determined.

After extensive experimental verification, the calculation formula for the depth of the raceway is solved finally in the embodiment.

$${D}_{R} = 0.2496 \cdot {{D}_{T} [ {{ρ}_{g 0} ( \frac{{V}_{g 0}}{{S}_{T}} )}^{2} \cdot \frac{1}{P} \cdot \frac{{T}_{m}}{{T}_{w}} \cdot \frac{1}{{ρ}_{P} \cdot {D}_{P c} \cdot g} ]}^{0.587} .$$

Step 2: establishing a boundary model for the blast furnace tuyere raceway through the depth calculation model for the blast furnace tuyere raceway, and determining a calculation formula for the boundary of the raceway.

When blast wind in the blast furnace tuyere raceway blows from the tuyere to the deepest position, the blast wind will continue to move up and down until it reaches the highest point in the tuyere raceway; therefore, the model can be derived by using the deepest position in the blast furnace tuyere raceway as a source of upward blast wind; the blast wind starts to blow up from the deepest position in the tuyere raceway and blows out of the cavity in the tuyere raceway until it reaches the highest point in the raceway; on the basis of an established formula of the depth calculation model for the blast furnace tuyere raceway, and the boundary model for each point at the boundary of the blast furnace tuyere raceway can be derived based on the principle of an equilibrium of forces due to the loss of the blast wind at the boundary of the raceway.

After being blown therein from the tuyere, high-temperature blast wind reaches the deepest point A in the raceway in the stroke being approximately a conical pipeline, and then the blast wind moves upwards; a micro element region B is formed at a horizontal distance of x meters from the raceway tuyere and a vertical distance of h meters from the raceway tuyere, with a cross-sectional area of S_{B}. At a point B, under a combined action of a blast wind gas impulse F_{D} and a resistance F_{b} of the coke layer at the point B, a balance state is achieved; at this time, it is considered that the raceway is in a stable operating state and satisfies an expression:

$${F}_{D} = {F}_{b} . \qquad ( 2 )$$

Wherein the magnitude of the blast wind gas impulse F_{D} is mainly proportional to a blast wind mass and a blast wind speed, namely:

$${F}_{D} ∝ ( \frac{{M}_{B} \cdot {U}_{B}}{{S}_{B}} ) \cdot {S}_{P} \qquad ( 3 )$$

In the expression, M_{B} represents a blast wind mass flow rate at the position, which specifically refers to a mass of fluid passing through a cross-section per unit time, namely:

$${M}_{B} ∝ {ρ}_{g} \cdot {V}_{g} \cdot ( 1 - σ L ) \qquad ( 4 )$$

Wherein ρ_{g} represents a blast wind density, V_{g} represents a blast wind volume, L represents a curve distance from the deepest position of the raceway to any point on the boundary of the raceway, and σ represents a loss rate of the blast wind on the boundary of the raceway.

L is further discussed, because the boundary from the deepest position of the raceway to any point on the boundary of the raceway is in a curved shape, assuming L is equal to (D_{R}−x)^{a}+h^{b}, wherein (x, h) is the coordinate of the point B relative to the tuyere, and a and b are curve parameters.

U_{B} represents a wind speed at the point B, which is proportional to the blast wind pressure and also directly proportional to the actual temperature inside the raceway, namely:

$${U}_{B} ∝ \frac{{M}_{B}}{{ρ}_{g} \cdot {S}_{B}} \cdot \frac{{P}_{0}}{P} \cdot \frac{{T}_{m}}{{T}_{0}} . \qquad ( 5 )$$

In the expression, M_{B} represents a blast wind mass flow rate at the point B, ρ_{g} represents the blast wind density, S_{B} represents a cross-sectional area of the point B, P represents the blast wind pressure, P₀ represents 1 standard atmospheric pressure, Tₘ represents the temperature of the raceway, actually measured using a temperature measuring instrument, and T₀ is equal to 298K.

S_{B} is the cross-sectional area of the point B, with the expressions:

$${S}_{B} ∝ ( 1 - σ ( {( {D}_{R} - x )}^{a} + {h}^{b} ) ) \cdot {S}_{A} \qquad ( 6 )$$

$$∝ ( 1 - σ L ) \cdot π \cdot {( \frac{{W}_{R}}{2} )}^{2} .$$

In the expression, W_{R} represents a width of the raceway.

Sₚ is a total cross-sectional area of coke particles at the point B, with the expression:

$${S}_{P} ∝ {\sum }_{i = 1}^{I} {( \frac{{D}_{PR}^{i}}{2} )}^{2} \cdot π \cdot ( 1 - σ L ) . \qquad ( 7 )$$

In the expression, D_{PR} represents a diameter of coke in front of the boundary of the raceway, DP, represents a diameter of the coke before entering the furnace, D_{PR}=0.6D_{PC}.

The expression of the blast wind gas impulse F_{D} at the point B can be further deduced as follows through combining equations (3) and (4):

$${F}_{D} ∝ {ρ}_{g} \cdot ( 1 - σ L ) \cdot ( \frac{{V}_{g}}{{S}_{B}} ) \cdot \frac{1}{P} \cdot \frac{{T}_{m}}{{T}_{0}} \cdot {S}_{P} . \qquad ( 8 )$$

The experiment proves that the relationship between the depth D_{R} of the raceway and the width W_{R} of the raceway is:

$$\frac{{W}_{R}}{{D}_{T}} ∝ {( \frac{{D}_{R}}{{D}_{T}} )}^{α} \cdot \qquad ( 9 )$$

In the equation, α is a constant, and α is equal to 0.2 to 0.6;

S_{T} is set to represent the area of the tuyere, with the expression:

$${S}_{T} ∝ {π ( \frac{{D}_{T}}{2} )}^{2} . \qquad ( 10 )$$

By combining equation (5), equation (8) and equation (9), it can be inferred:

$$\frac{{s}_{A}}{{s}_{T}} ∝ {( \frac{{W}_{R}}{{D}_{T}} )}^{2} ∝ {( \frac{{D}_{R}}{{D}_{T}} )}^{2 α} . \qquad ( 11 )$$

Finally, the final expression of the blast wind gas impulse F_{D} at the point B can be obtained as follows through substituting the equation (10) into the equation (7):

$${F}_{D} ∝ {ρ}_{g} \cdot ( 1 - σ ( {( {D}_{R} - x )}^{a} + {h}^{b} ) ) \cdot {( \frac{{V}_{g}}{{S}_{T}} )}^{2} \cdot {( \frac{{D}_{R}}{{D}_{T}} )}^{a} \cdot \frac{{T}_{m}}{{T}_{W}} \cdot {S}_{P} . \qquad ( 12 )$$

F_{b} represents the resistance of the coke layer at the point B to a blast wind airflow, which is mainly determined by a compaction degree of the coke, and is approximately proportional to the gravity of coke granules and the blast wind pressure, namely:

$${F}_{b} ∝ \frac{H - h}{H} \cdot {ρ}_{P} \cdot {V}_{P} \cdot g ∝ \frac{H - h}{H} \cdot {ρ}_{p} \cdot {P ( \frac{{D}_{P R}}{2} )}^{3} \cdot g . \qquad ( 13 )$$

In the expression, ρₚ represents the coke density, V_{P} represents the volume of the coke particles at the point A, g represents the acceleration of gravity, D_{PR} represents the diameter of the coke in front of the boundary of the raceway, P represents the blast wind pressure, H represents a total height of the blast furnace, and h represents a vertical distance from the point B to the tuyere; the blast wind density ρ_{g} can be further expressed as:

$${ρ}_{g} = {ρ}_{g 0} \cdot \frac{{T}_{0}}{{T}_{w}} \cdot \frac{P}{{P}_{0}} . \qquad ( 14 )$$

In the expression, ρ_{g0} represents the blast wind density under the standard state, T_{w} represents the blast wind temperature, P represents the blast wind pressure, and P₀ represents 1 standard atmospheric pressure.

Finally, by substituting the expressions (11), (12) and (13) into the expression (1), the calculation formula for the boundary of the raceway can be obtained as follows:

$${K}_{1} \cdot {x}^{2} - 2 {K}_{1} \cdot {D}_{R} \cdot x + {K}_{1} \cdot {h}^{2} - {K}_{2} \cdot h = {K}_{3} , \qquad ( 15 )$$

$$wherein$$

$${K}_{1} = {K}_{3} \cdot \frac{{V}_{g}^{2} \cdot {D}_{R}^{a} \cdot {T}_{m} \cdot σ}{P \cdot {T}_{w}} , \qquad ( 16 )$$

$${K}_{2} = {K}_{4} \cdot \frac{{ρ}_{p} \cdot {D}_{P R}^{3} \cdot g}{H} P , \qquad ( 17 )$$

$${K}_{3} = {K}_{4} \cdot {ρ}_{p} \cdot {D}_{P R}^{3} \cdot g \cdot P - \frac{{ρ}_{g} \cdot {S}_{P}}{{S}_{T}^{2} \cdot {D}_{T}^{a}} \cdot \frac{{V}_{g}^{2} \cdot {D}_{R}^{a} \cdot {T}_{m}}{P \cdot {T}_{w}} + \frac{{ρ}_{g} \cdot {S}_{P} \cdot σ}{{S}_{T}^{2} \cdot {D}_{T}^{a}} \cdot \frac{{V}_{g}^{2} \cdot {D}_{R}^{a + 2} \cdot {T}_{m}}{P \cdot {T}_{w}} . \qquad ( 18 )$$

Wherein K₃ and K₄ are coefficients to be determined.

By using the calculation formula for the boundary of the raceway mentioned above, a mathematical model of the raceway can be further established to study the trend of changes in the boundary of the raceway.

Step 3: obtaining modelling parameters, analyzing an impact of the modelling parameters on the boundary model for the raceway, and determining main parameters that affect the boundary of the raceway.

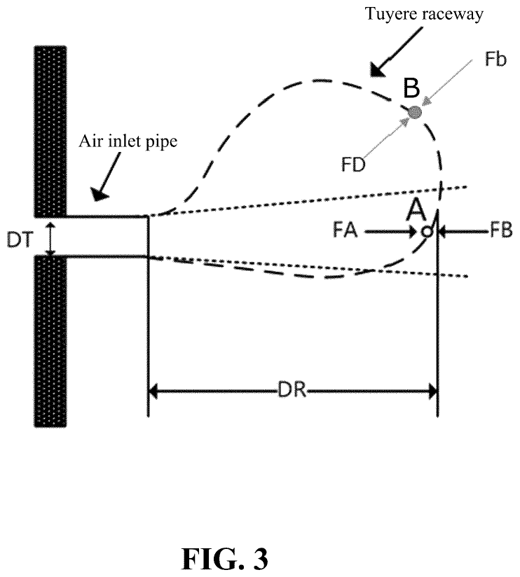

According to the boundary model for the raceway as shown in FIG. 3 and relevant parameters involved in modelling, and a change law of the boundary of the raceway, the blast wind pressure P and the blast wind volume V_{g} in blast wind parameters, as well as the temperature Tₘ of the raceway have a direct impact on the changes of the boundary of the raceway; according to the calculation formula for the boundary of the raceway, reducing the blast wind pressure P, increasing the blast wind volume V_{g} and increasing the temperature Tₘ of the raceway are all beneficial for developing the raceway towards a center and increasing the depth of the raceway, so that the boundary of the raceway is expanded outwards, which meets the change law of the boundary of the raceway in the actual blast furnace smelting process, and at the same time, the rationality of the above calculation formula for the tuyere raceway is preliminarily verified; wherein the blast wind pressure P and the blast wind volume V_{g} can be adjusted, while the changes of the temperature Tₘ in the raceway are influenced by various factors, whereby the temperature cannot be directly adjusted to cause changes.

In the embodiment, the relevant parameters used in the modelling process of the boundary model of the raceway are shown in Table 1:

TABLE 1
relevant parameters used in the modelling process
of the boundary model of the raceway.

| | |
|---|---|
| F_{A} | blast wind gas impulse at point A |
| F_{B} | resistance of coke layer to blast wind airflow |
| | at point A |
| M_{A} | blast wind mass flow rate at point A |
| U_{A} | wind speed at point A |
| S_{A} | cross-sectional area of blast wind airflow at |
| | point A |
| S_{P} | total cross-sectional area of coke particles at |
| | point A |
| S_{T} | area of tuyere |
| ρ_{g0} | blast wind density under standard state |
| ρ_{g} | blast wind density |
| ρₚ | coke density |
| V_{g} | blast wind volume |
| V_{P} | volume of coke particles at point A |
| P | blast wind pressure |
| Tₘ | temperature actually measured by CCD |
| | temperature measuring instrument |
| T_{W} | blast wind temperature |
| D_{PR} | diameter of coke particles |
| D_{Pc} | diameter of coke before entering furnace |
| D_{R} | depth of raceway |
| W_{R} | width of raceway |
| D_{T} | diameter of tuyere |

Step 4: solving a height of the raceway through the calculation formula for the boundary of the raceway.

Deriving a variable h in the calculation formula for the boundary of the raceway, and making the derived result equal to zero, thereby calculating a maximum value of the raceway in a vertical direction, that is, the height of the raceway, as shown in the following formula:

$$G = \frac{{K}_{2}}{2 \cdot {K}_{1}} = \frac{{ρ}_{P} \cdot {D}_{P R}^{3} \cdot g \cdot {P}^{2} \cdot {T}_{w}}{{K}_{5} \cdot {V}_{g}^{2} \cdot {D}_{R}^{a} \cdot {T}_{m} \cdot H} .$$

Wherein G is the height of the raceway, and K₅ is a coefficient to be determined.

After extensive experimental verification, finally K₅ being equal to 2.12 is obtained, and the calculation formula for the height of the raceway is:

$$G = \frac{{K}_{2}}{2 \cdot {K}_{1}} = \frac{{ρ}_{P} \cdot {D}_{P R}^{3} \cdot g \cdot {P}^{2} \cdot {T}_{w}}{2.12 \cdot {V}_{g}^{2} \cdot {D}_{R}^{a} \cdot {T}_{m} \cdot H} .$$

Step 5: when the height or the depth of the raceway exceeds a set range, adjusting the blast wind pressure P and the blast wind volume V_{g} to restore the height or the depth of the raceway to a normal range.

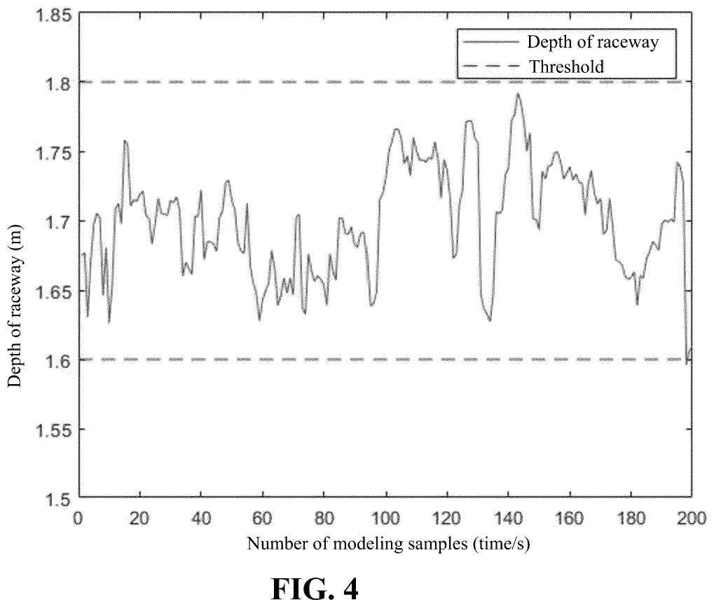

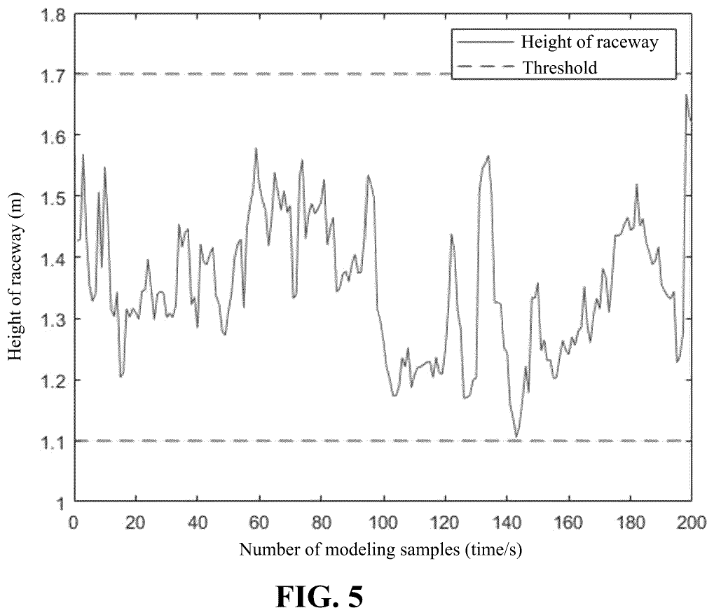

In the embodiment, the changes in the depth and height of the raceway under smooth operation of the blast furnace are shown as FIG. 4. All the parameters and data used for modelling are from the 4000 m³ blast furnace. In actual blast furnace smelting, the depth of the raceway of the 4000 m³ blast furnace under normal conditions is between 1.6 m and 1.8 m, and the height of the raceway is between 1.1 m and 1.7 m. From FIG. 4 and FIG. 5, it can be seen that the blast furnace production at this time is in a normal state. The depth of the raceway fluctuates between 1.65 m and 1.75 m, and the height of the raceway fluctuates between 1.1 m and 1.68 m, both are within the normal range.

Finally, it should be noted that the above embodiments are merely intended to describe the technical solutions of the present invention, rather than to limit the present invention. Although the present invention is described in detail with reference to the above embodiments, those ordinary skilled in the art should understand that they may still make modifications to the technical solutions described in the above embodiments or make equivalent replacements to some or all technical features thereof. However, these modifications or replacements do not cause the essence of the corresponding technical solutions to depart from the scope of the technical solutions of the embodiments of the present invention.

What is claimed is:

1. A calculating and real-time monitoring method for a boundary of a blast furnace tuyere raceway, comprising:
Step 1: establishing a depth calculation model for the raceway according to a formation principle of the blast furnace tuyere raceway, and further obtaining a calculation formula for a depth of the raceway so as to obtain a change law of the depth of the raceway;
Step 2: establishing a boundary model for the blast furnace tuyere raceway through the depth calculation model for the blast furnace tuyere raceway, and determining a calculation formula for the boundary of the raceway;
Step 3: obtaining modelling parameters, analyzing an impact of the modelling parameters on the boundary model for the raceway, and determining main parameters that affect the boundary of the raceway;
Step 4: solving a height of the raceway through the calculation formula for the boundary of the raceway; and
Step 5: when the height or the depth of the raceway exceeds a set range, adjusting a blast wind pressure and a blast wind volume to restore the height or the depth of the raceway to a normal range.

2. The method according to claim 1, wherein Step 1 comprises:
when a cavity in the raceway is in a stable motion state, taking a micro element region A at a deepest position inside the raceway as a research object, at this time, enabling the region A to be balanced under a combined action of a blast wind gas impulse and a resistance of a coke layer, and establishing the depth calculation model for the raceway according to an equilibrium of two forces to solve changes of the depth of the raceway, as shown in the following formulas:
$${F}_{A} ∝ {{ρ}_{g 0} ( \frac{{y}_{g}}{{s}_{T}} )}^{2} \cdot {( \frac{{D}_{T}}{{D}_{R}} )}^{4 α} \cdot \frac{{T}_{m}}{{T}_{w}} \cdot {S}_{P} ,$$
$${F}_{B} ∝ {ρ}_{p} \cdot {V}_{p} \cdot g \cdot P ∝ {ρ}_{P} \cdot \frac{4}{3} π \cdot {( \frac{{D}_{P R}}{2} )}^{3} \cdot g \cdot P ,$$
wherein F_{A} represents the blast wind gas impulse at the region A, F_{B} represents the resistance of the coke layer at the region A, ρ_{g0} represents a blast wind density in a standard state, V_{g} represents the blast wind volume at the region A, S_{T} represents an area of a tuyere, D_{R} represents the depth of the raceway, D_{T} represents a diameter of the tuyere, a is a constant which is used for representing a relationship between the depth and a width of the raceway, P represents the blast wind pressure, Tₘ represents a temperature of the raceway, S_{P} represents a total cross-sectional area of coke particles at the region A, ρₚ represents a coke density, V_{P} represents a volume of the coke particles at the region A, g represents an acceleration of gravity, D_{PR} represents a diameter of coke in front of the boundary of the raceway, D_{PR}=0.6D_{PC},D_{PC}, represents a diameter of the coke before entering a furnace, and T_{w} represents a blast wind temperature, and
the calculation formula for the depth of the raceway is obtained through the depth calculation model for the raceway:
$${D}_{R} = K \cdot {{D}_{T} [ {{ρ}_{g} ( \frac{{V}_{g}}{{S}_{T}} )}^{2} \cdot \frac{1}{P} \cdot \frac{{T}_{m}}{{T}_{w}} \cdot \frac{1}{{ρ}_{P} \cdot {D}_{P c} \cdot g} ]}^{β} ,$$
wherein K and β both are coefficients to be determined, and ρ_{g} represents a blast wind density under an actual wind temperature and wind pressure.

3. The method according to claim 2, wherein Step 2 comprises:
when an internal motion of the raceway is in a stable state, randomly taking a point B at the boundary of the raceway as a research object, at this time, enabling the point B to be balanced under the combined action of the blast wind gas impulse and the resistance of the coke layer, and establishing a mathematical model for any point at the boundary of the raceway according to the equilibrium of two forces to solve changes of the boundary of the raceway:
$${F}_{D} ∝ \frac{( {M}_{B} \cdot {U}_{B} )}{{s}_{B}} \cdot {S}_{P} ,$$
$${F}_{D} ∝ {ρ}_{g} \cdot ( 1 - σ ( {( {D}_{R} - x )}^{a} + {h}^{b} ) ) \cdot {( \frac{{V}_{g}}{{S}_{T}} )}^{2} \cdot {( \frac{{D}_{R}}{{D}_{T}} )}^{a} \cdot \frac{{T}_{m}}{{T}_{W}} \cdot {S}_{P} ,$$
$$wherein$$
$${S}_{P} ∝ {\sum }_{i = 1}^{I} {( \frac{{D}_{P R}^{i}}{2} )}^{2} \cdot π \cdot ( 1 - σ L ) ,$$
$${M}_{B} ∝ {ρ}_{g} \cdot {V}_{g} \cdot ( 1 - σ L ) ,$$
$${U}_{B} ∝ \frac{{M}_{B}}{{ρ}_{g} \cdot {S}_{B}} \cdot \frac{{P}_{0}}{P} \cdot \frac{{T}_{m}}{{T}_{0}} ,$$
$${S}_{B} ∝ ( 1 - σ ( {( {D}_{R} - x )}^{a} + {h}^{b} ) ) \cdot {S}_{A} ,$$
$${F}_{b} ∝ \frac{H - h}{H} \cdot {ρ}_{P} \cdot {V}_{P} \cdot g ∝ \frac{H - h}{H} \cdot {ρ}_{p} \cdot {P ( \frac{{D}_{P R}}{2} )}^{3} \cdot g ,$$
in which F_{D} represents a blast wind gas impulse at the point B, F_{b} represents a resistance of the coke layer at the point B to a blast wind airflow, M_{B} represents a blast wind mass flow rate at the point B, U_{B} represents a wind speed at the point B, S_{B} represents a cross-sectional area of the point B, S_{A} represents a cross-sectional area of the region A, ρ_{g} represents the blast wind density under the actual wind temperature and wind pressure, P₀ represents 1 standard atmospheric pressure, L represents a curve distance from the deepest position of the raceway to any point on the boundary of the raceway, σ represents a loss rate of blast wind on the boundary of the raceway, H represents a total height of a blast furnace, h represents a vertical distance from the point B to the tuyere, a and b are shape parameters of the boundary of the raceway, I represents a total number of coke granules included in the cross-section at the point B, and D_{PR}ⁱ is a diameter of an i^{th} coke granule at the point B of the raceway;
because the boundary from the deepest position of the raceway to any point on the boundary of the raceway is in a curved shape, L=(D_{R}−x)^{a}+h^{b} is set, and wherein coordinates of the point B of the raceway relative to the tuyere are (x, h);
the calculation formula for the boundary of the raceway is further obtained through the mathematical model for any point at the boundary of the raceway:
$${K}_{1} \cdot {x}^{2} - 2 {K}_{1} \cdot {D}_{R} \cdot x + {K}_{1} \cdot {h}^{2} - {K}_{2} \cdot h = {K}_{3} ,$$
$$wherein$$
$${K}_{1} = {K}_{3} \cdot \frac{{V}_{g}^{2} \cdot {D}_{R}^{a} \cdot {T}_{m} \cdot σ}{P \cdot {T}_{w}} ,$$
$${K}_{2} = {K}_{4} \cdot \frac{{ρ}_{p} \cdot {D}_{P R}^{3} \cdot g}{H} P ,$$
$${K}_{3} = {K}_{4} \cdot {ρ}_{p} \cdot {D}_{P R}^{3} \cdot g \cdot P - \frac{{ρ}_{g} \cdot {S}_{P}}{{S}_{T}^{2} \cdot {D}_{T}^{a}} \cdot \frac{{V}_{g}^{2} \cdot {D}_{R}^{a} \cdot {T}_{m}}{P \cdot {T}_{w}} + \frac{{ρ}_{g} \cdot {S}_{P} \cdot σ}{{S}_{T}^{2} \cdot {D}_{T}^{a}} \cdot \frac{{V}_{g}^{2} \cdot {D}_{R}^{a + 2} \cdot {T}_{m}}{P \cdot {T}_{w}} ,$$
wherein K₄ and K₄ are coefficients to be determined.

4. The method according to claim 3, wherein Step 3 comprises:
according to the boundary model for the raceway and relevant parameters involved in modelling, and a change law of the boundary of the raceway, the blast wind pressure P and the blast wind volume V_{g} in blast wind parameters, as well as the temperature Tₘ of the raceway and the loss rate σ of the blast wind at the coke of the raceway in the blast wind parameters, have a direct impact on the changes of the boundary of the raceway; according to the calculation formula for the boundary of the raceway, reducing the blast wind pressure P, increasing the blast wind volume V_{g} and increasing the temperature Tₘ and reducing the loss rate of the blast wind at the coke of the raceway are all beneficial for developing the raceway towards a center and increasing the depth of the raceway, wherein the blast wind pressure P and the blast wind volume V_{g} are adjustable, while changes of the temperature Tₘ in the raceway are influenced by various factors, whereby the temperature is not directly adjustable to cause changes.

5. The method according to claim 4, wherein Step 4 comprises:
deriving a variable h in the calculation formula for the boundary of the raceway, and making the derived result equal to zero, thereby calculating a maximum value of the raceway in a vertical direction, that is, the height of the raceway, as shown in the following formula:
$$G = \frac{{K}_{2}}{2 \cdot {K}_{1}} = \frac{{ρ}_{P} \cdot {D}_{P R}^{3} \cdot g \cdot {P}^{2} \cdot {T}_{w}}{{K}_{5} \cdot {V}_{g}^{2} \cdot {D}_{R}^{a} \cdot {T}_{m} \cdot H} ,$$
wherein G is the height of the raceway, and K₅ is a coefficient to be determined.
